(19) United States
(12) Patent Application Publication
(10) Pub. No.: US 2017/0302368 A1
(43) Pub. Date: Oct. 19, 2017

(54) Predicting Signal Quality in a Rotating Beam Platform

(71) Applicant: Google Inc., Mountain View, CA (US)

(72) Inventor: Mitchell Trott, San Mateo, CA (US)

(73) Assignee: Google Inc., Mountain View, CA (US)

(21) Appl. No.: 15/097,599

(22) Filed: Apr. 13, 2016

(51) Int. Cl. H04B 7/204; H04B 7/185

(52) U.S. Cl. CPC H04B 7/2041; H04B 7/18504; H04B 7/18506

(57) ABSTRACT

A method of receiving a target position and a target orientation of an airborne base station; predicting a target signal quality of the airborne base station at the target position and the target orientation based on at least one previous signal quality of the airborne base station corresponding to at least one previous position and at least one previous orientation of the airborne base station relative to the ground reference. Each previous signal quality of the airborne base station is measured by one or more terrestrial terminals located in corresponding one or more communication beams of the airborne base station. The method further includes selecting a target communication beam among the communication beams of the airborne base station for a communication link.

### TECHNICAL FIELD

This disclosure relates to predicting signal quality in a rotating beam platform.

### BACKGROUND

A communication network is a large distributed system for receiving information (signal) and transmitting the information to a destination. Over the past few decades the demand for communication access has dramatically increased. Although conventional wire and fiber landlines, cellular networks, and geostationary satellite systems have continuously been increasing to accommodate the growth in demand, the existing communication infrastructure is still not large enough to accommodate the increase in demand. Airborne communication networks provisioned for wireless communication services can aid coverage and capacity of the communication network.

An airborne communication networks sometimes includes satellites and/or high altitude platform stations (HAPSs). A HAPS is generally considered as a station on an object (e.g., a high-altitude balloon or an aircraft system) at an altitude of 17 to 50 km and at a specified, nominal, fixed point relative to Earth. The station typically has equipment for carrying on communications via radio waves. Generally, the equipment includes a receiver and/or a transmitter, an antenna, and control circuitry. In operation, the HAPS may fly in a particular pattern or along a particular path for a duration of time.

### SUMMARY

An airborne base station may project multiple antenna beams on to a ground surface to cover a large area. The beams increase the capacity of the airborne base station by allowing a limited radio frequency (RF) spectrum to be reused in each beam, while maintaining limited beam-to-beam RF coupling. The airborne base station performs ‘station keeping’ by moving in a circular pattern in the sky (e.g., completing each circuit in minutes). This motion causes the beam pattern on the ground to rotate at a rapid rate. The airborne base station may include or be in communication with a base station scheduler that selects an appropriate beam to use for transmission to a user equipment (UE) at various times. The present disclosure describes predicting signal quality in a rotating beam platform (e.g., an airborne base station performing station keeping) to facilitate selection of an appropriate beam to use for transmission to a UE at various times.

One aspect of the disclosure provides a method for predicting signal quality from an airborne base station. The method includes receiving, at data processing hardware, a target position and a target orientation of an airborne base station relative to a ground reference. The method also includes predicting, by the data processing hardware, a target signal quality of the airborne base station at the target position and the target orientation based on at least one previous signal quality of the airborne base station corresponding to at least one previous position and at least one previous orientation of the airborne base station relative to the ground reference. Each previous signal quality of the airborne base station is measured by one or more terrestrial terminals located in corresponding one or more cells of the airborne base station. Each cell corresponds to a different communication beam of the airborne base station. The airborne base station has a plurality of communication beams. The method further includes selecting, by the data processing hardware, a target communication beam among the communication beams of the airborne base station for a communication link between a target terrestrial terminal and the airborne base station. The communication link exists for a period of time relative to a current position and a current orientation of the airborne base station.

Implementations of the disclosure may include one or more of the following optional features. In some implementations, at least one previous signal quality includes a reference signal receive power measurement. The method may also include transmitting, by the data processing hardware, data using the target communication beam. The method may further include delaying, by the data processing hardware, transmission of the data using the target communication beam until the target signal quality satisfies a threshold signal quality.

In some examples, when the target signal quality of the target communication beam fails to satisfy a threshold signal quality, the method includes selecting, by the data processing hardware, an alternative communication beam among the communication beams of the airborne base station for the communication link between the target terrestrial terminal and the airborne base station and transmitting, by the data processing hardware, data using the alternative communication beam. The alternative communication beam is different from the target communication beam. The target position may include a current position or a future position of the airborne base station. Predicting the target signal quality may be based at least in part on a Fourier series expansion using multiples of a base period. The target signal quality may be estimated using a sounding reference signal. The airborne base station may maintain a flight path within a majority of a line of sight of the target terrestrial terminal. The airborne base station may also maintain a flight path having a diameter that is approximately at or less than a diameter of earth.

Another aspect of the disclosure provides a method for predicting signal quality from an airborne base station. The method includes receiving, at data processing hardware, a first collection of signal quality measurements of a plurality of communication beams of an airborne base station at a first position and a first orientation relative to a ground reference. The method also includes receiving, at data processing hardware, a second collection of signal quality measurements of the plurality of communication beams of the airborne base station at a second position and a second orientation relative to the ground reference. The method includes predicting, by the data processing hardware, a target signal quality of multiple communication beams of the airborne base station at a target position and a target orientation relative to the ground reference based on the first and second collections of signal quality measurements. The method further includes selecting, by the data processing hardware, a target communication beam among the plurality of communication beams of the airborne base station that satisfies a threshold signal quality for communicating with a target terrestrial terminal during a period of time relative to the target position and the target orientation of the airborne base station.

This aspect may include one or more of the following optional features. In some implementations, each signal quality measurement includes a reference signal receive power measurement. The method may also include transmitting, by the data processing hardware, data using the target communication beam. The method may further include delaying, by the data processing hardware, transmission of the data using the target communication beam until the target signal quality of the target communication beam satisfies the threshold signal quality. When the target signal quality of the target communication beam fails to satisfy a threshold signal quality, the method includes selecting, by the data processing hardware, an alternative communication beam among the plurality of communication beams of the airborne base for communicating between the target terrestrial terminal and the airborne base station and transmitting, by the data processing hardware, data using the alternative communication beam. The alternative communication beam is different from the target communication beam.

In some examples, predicting the target signal quality of the multiple communication beams of the airborne base station at the target position and the target orientation relative to the ground reference may be at least in part based on one or both of a target terrestrial area of the target terrestrial terminal or a target terrestrial position of the target terrestrial terminal. The target orientation may include an azimuth, an elevation, and a roll. Predicting the target signal quality of the multiple communication beams of the airborne base station at the target position and the target orientation relative to the ground reference may also be based on at least one of a channel quality indicator, a sounding reference signal, or a periodic measurement. Predicting the target signal quality of the multiple communication beams of the airborne base station at the target position and the target orientation relative to the ground reference may further be based at least in part on a Fourier series expansion using multiples of a base period. Predicating the target signal quality of the multiple communication beams of the airborne base station at the target position and the target orientation relative to the ground reference may also be based at least in part on a median signal quality value of over a base period.

In some examples, the airborne base station maintains a flight path within a majority of a line of sight of the target terrestrial terminal. The airborne base station may maintain a flight path with a diameter that is at or less than 25 miles. The airborne base station may also maintain a flight path having a diameter that is at or less than a diameter of earth.

Yet another aspect of the disclosure provides a system for predicting signal quality from an airborne base station. The system includes data processing hardware and memory hardware in communication with the data processing hardware. The memory hardware stores instructions that when executed on the data processing hardware cause the data processing hardware to perform operations. The operations include: receiving a target position and a target orientation of an airborne base station relative to a ground reference; predicting a target signal quality of the airborne base station at the target position and the target orientation based on at least one previous signal quality of the airborne base station corresponding to at least one previous position and at least one previous orientation of the airborne base station relative to the ground reference; and selecting a target communication beam among the communication beams of the airborne base station for a communication link between a target terrestrial terminal and the airborne base station. Each previous signal quality of the airborne base station is measured by one or more terrestrial terminals located in corresponding one or more cells of the airborne base station. Moreover, each cell corresponds to a different communication beam of the airborne base station. The airborne base station has a plurality of communication beams. The communication link exists for a period of time relative to a current position and a current orientation of the airborne base station.

This aspect may include one or more of the following optional features. In some implementations, at least one previous signal quality includes a reference signal receive power measurement. The operations may also include transmitting data using the target communication beam. The operations may further include delaying transmission of the data using the target communication beam until the target signal quality satisfies a threshold signal quality. When the target signal quality of the target communication beam fails to satisfy a threshold signal quality, the operations include selecting an alternative communication beam among the communication beams of the airborne base station for the communication link between the target terrestrial terminal and the airborne base station and transmitting data using the alternative communication beam. The alternative communication beam is different from the target communication beam.

In some examples, the target positions include a current position or a future position of the airborne base station. Predicting the target signal quality may be based at least in part on a Fourier series expansion using multiples of a base period. The target signal quality may be estimated using a sounding reference signal. The airborne base station may maintain a flight path within a majority of a line of sight of the target terrestrial terminal or a flight path having a diameter that is approximately at or less than a diameter of earth.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary communication system.

FIG. 1B is a schematic view of an exemplary global-scale communication system with satellites and communication balloons, where the satellites form a polar constellation.

FIG. 1C is a schematic view of an exemplary group of satellites of FIG. 1A forming a Walker constellation.

FIGS. 2A and 2B are perspective views of example airborne base stations.

FIG. 3 is a perspective view of an example satellite.

FIG. 4 is a schematic view of an exemplary communication system that includes an airborne base station and a terrestrial terminal.

FIG. 5A displays a perspective schematic view of an airborne base station operating.

FIG. 5B is a top view of an exemplary pattern of communication beams projected an airborne base station.

FIG. 5C shows a graph of example perceived signal quality in reference to a terrestrial terminal for a first communication beam.

FIG. 5D shows a graph of example perceived second signal quality in reference to a terrestrial terminal for a second communication beam.

FIG. 5E displays a graph of example signal quality with respect to position and orientation for a given communication beam.

FIG. 6 displays a schematic view of an exemplary method for predicting signal quality from an airborne base station.

FIG. 7 displays a schematic view of an exemplary method for predicting signal quality from an airborne base station.

FIG. 8 is a schematic view of an exemplary computer system for operation of the method.

Like reference symbols in the various drawings indicate like elements.

### DETAILED DESCRIPTION

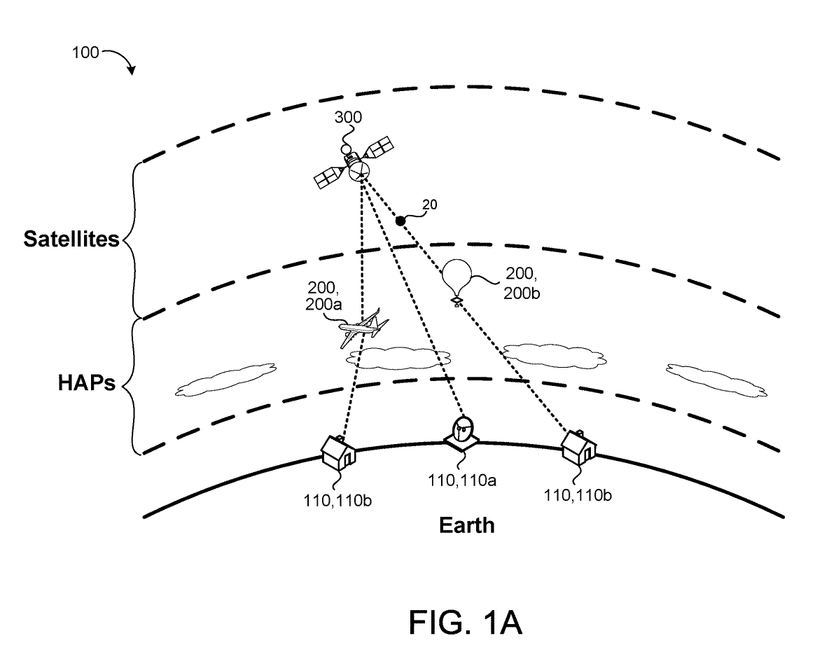

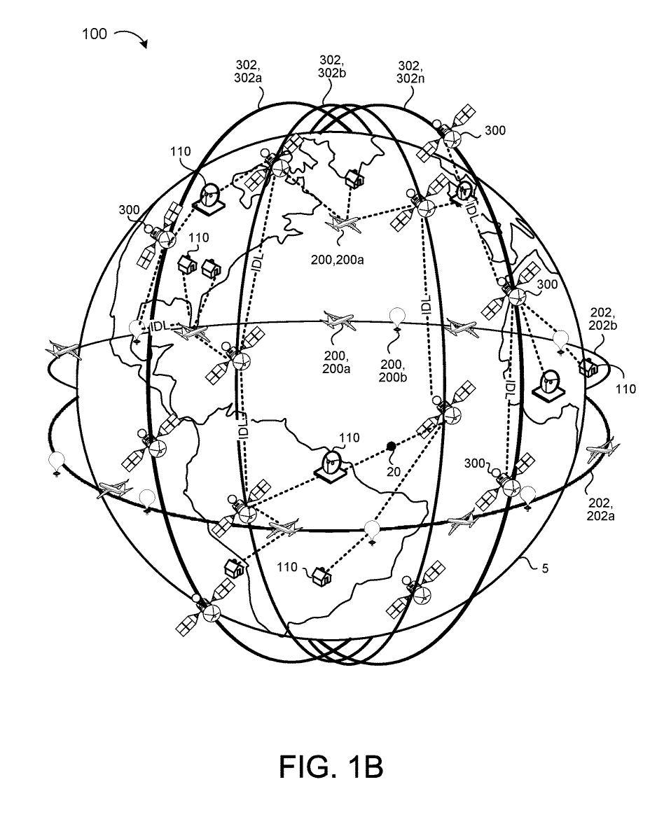

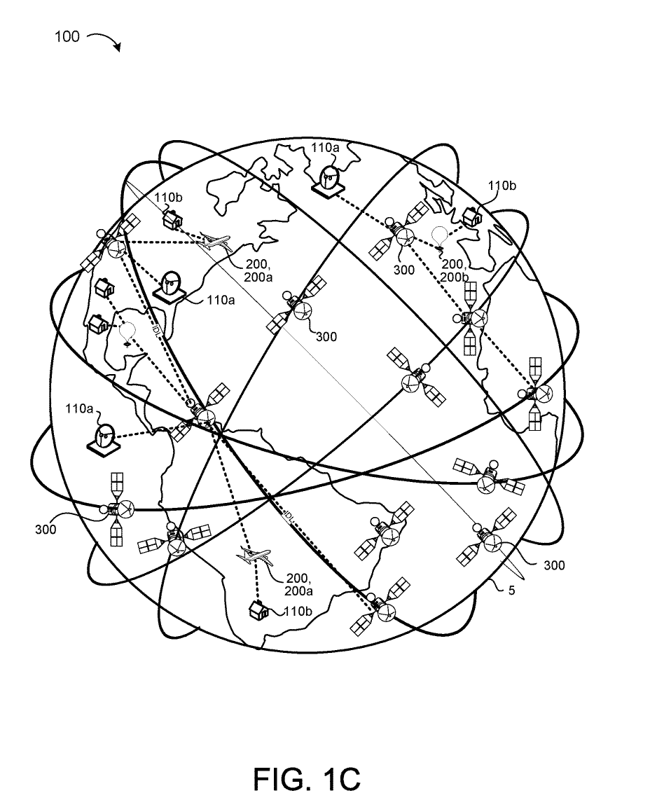

Referring to FIGS. 1A-1C, in some implementations, a global-scale communication system 100 includes gateways 110 (e.g., source ground stations 110a and destination ground stations 110b), high altitude platforms (HAPs) or airborne base station 200, and satellites 300. In some examples, the gateways 110 are mobile handsets, such as smartphones. High altitude platforms (HAPs) and airborne base station 200 may be used interchangeably. The source ground stations 110a may communicate with the satellites 300, the satellites 300 may communicate with the airborne base stations 200, and the airborne base stations 200 may communicate with the destination ground stations 110b. In some examples, the source ground stations 110a also operate as linking-gateways between satellites 300. The source ground stations 110a may be connected to one or more service providers and the destination ground stations 110b may be user terminals (e.g., mobile devices, residential WiFi devices, home networks, etc.). In some implementations, an airborne base station 200 is an aerial communication device that operates at high altitudes (e.g., 17-22 km). The airborne base station may be released into the earth's atmosphere, e.g., by an air craft, or flown to the desired height. Moreover, the airborne base station 200 may operate as a quasi-stationary aircraft. In some examples, the airborne base station 200 is an aircraft 200a, such as an unmanned aerial vehicle (UAV); while in other examples, the airborne base station 200 is a communication balloon 200b. The satellite 300 may be in Low Earth Orbit (LEO), Medium Earth Orbit (MEO), or High Earth Orbit (HEO), including Geosynchronous Earth Orbit (GEO).

The airborne base stations 200 may move about the earth 5 along a path, trajectory, or orbit 202 (also referred to as a plane, since their orbit or trajectory may approximately form a geometric plane). Moreover, several airborne base stations 200 may operate in the same or different orbits 202. For example, some airborne base stations 200 may move approximately along a latitude of the earth 5 (or in a trajectory determined in part by prevailing winds) in a first orbit 202a, while other airborne base stations 200 may move along a different latitude or trajectory in a second orbit 202b. The airborne base stations 200 may be grouped amongst several different orbits 202 about the earth 5 and/or they may move along other paths 202 (e.g., individual paths). Similarly, the satellites 300 may move along different orbits 302, 302a-n. Multiple satellites 300 working in concert form a satellite constellation. The satellites 300 within the satellite constellation may operate in a coordinated fashion to overlap in ground coverage. In the example shown in FIG. 1B, the satellites 300 operate in a polar constellation by having the satellites 300 orbit the poles of the earth 5; whereas, in the example shown in FIG. 1C, the satellites 300 operate in Walker constellation, which covers areas below certain latitudes and provides a larger number of satellites 300 simultaneously in view of a gateway 110 on the ground (leading to higher availability, fewer dropped connections).

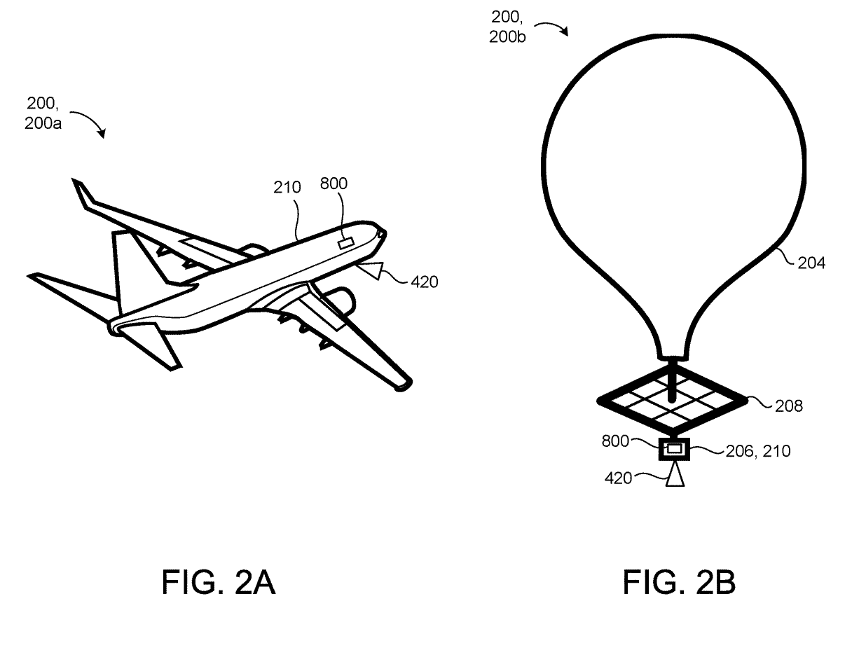

Referring to FIGS. 2A and 2B, in some implementations, the airborne base station 200 includes an airborne base station body 210 and an antenna 420 disposed on the airborne base station body 210 that receives a communication 20 from a satellite 300 and reroutes the communication 20 to a destination ground station 110b and vice versa. The antenna(s) 420 may be rigidly mounted to the airborne base station body 210 or affixed to movable apparatus, e.g., a gimbal system that attempts to compensate partially or fully for changes in the attitude (e.g., current pitch, yaw, and roll or a pose) of the airborne base station body 210. One type of gimbal system corrects for elevation and roll, but not azimuth. The airborne base station 200 may include a data processing device 800 that processes the received communication 20 and determines a path of the communication 20 to arrive at the destination ground station 110b (e.g., user terminal). In some implementations, terrestrial terminals 110b on the ground have specialized antennas that send communication signals to the airborne base stations 200. The airborne base station 200 receiving the communication 20 sends the communication 20 to another airborne base station 200, to a satellite 300, or to a gateway 110 (e.g., a terrestrial terminal 110b).

FIG. 2B illustrates an example communication balloon 200b that includes a balloon 204 (e.g., sized about 49 feet in width and 39 feet in height and filled with helium or hydrogen), an equipment box 206 as an airborne base station body 210, and solar panels 208. The equipment box 206 includes a data processing device 800 that executes algorithms to determine where the high-altitude balloon 200a needs to go, then each high-altitude balloon 200b moves into a layer of wind blowing in a direction that will take it where it should be going. The equipment box 206 also includes batteries to store power and a transceiver (e.g., antennas 420) to communicate with other devices (e.g., other airborne base stations 200, satellites 300, gateways 110, such as terrestrial terminals 110b, internet antennas on the ground, etc.). The solar panels 208 may power the equipment box 206.

Communication balloons 200a are typically released in to the earth's stratosphere to attain an altitude between 11 to 23 miles and provide connectivity for a ground area of 25 miles in diameter at speeds comparable to terrestrial wireless data services (such as, 3G or 4G). The communication balloons 200a float in the stratosphere at an altitude twice as high as airplanes and the weather (e.g., 20 km above the earth's surface). The high-altitude balloons 200a are carried around the earth 5 by winds and can be steered by rising or descending to an altitude with winds moving in the desired direction. Winds in the stratosphere are usually steady and move slowly at about 5 and 20 mph, and each layer of wind varies in direction and magnitude.

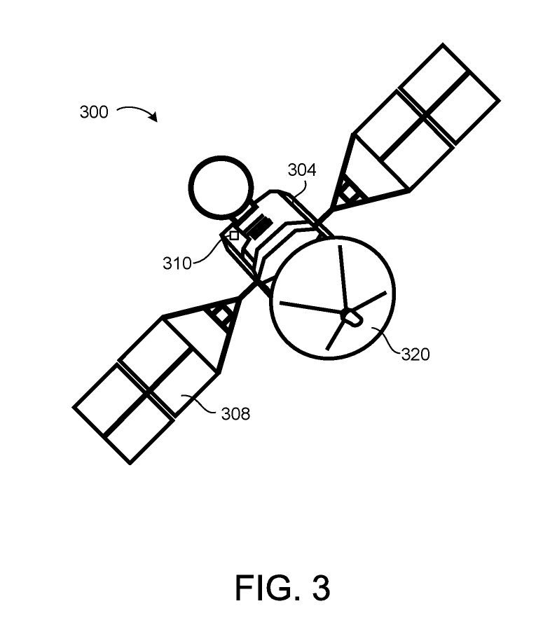

Referring to FIG. 3, a satellite 300 is an object placed into orbit 302 around the earth 5 and may serve different purposes, such as military or civilian observation satellites, communication satellites, navigations satellites, weather satellites, and research satellites. The orbit 302 of the satellite 300 varies depending in part on the purpose of the satellite 200b. Satellite orbits 302 may be classified based on their altitude from the surface of the earth 5 as Low Earth Orbit (LEO), Medium Earth Orbit (MEO), and High Earth Orbit (HEO). LEO is a geocentric orbit (i.e., orbiting around the earth 5) that ranges in altitude from 0 to 1,240 miles. MEO is also a geocentric orbit that ranges in altitude from 1,200 mile to 22,236 miles. HEO is also a geocentric orbit and has an altitude above 22,236 miles. Geosynchronous Earth Orbit (GEO) is a special case of HEO. Geostationary Earth Orbit (GSO, although sometimes also called GEO) is a special case of Geosynchronous Earth Orbit.

In some implementations, a satellite 300 includes a satellite body 304 having a data processing device 800, e.g., similar to the data processing device 800 of the airborne base stations 200. The data processing device 800 executes algorithms to determine where the satellite 300 is heading. The satellite 300 also includes an antenna 320 for receiving and transmitting a communication 20. The satellite 300 includes solar panels 308 mounted on the satellite body 304 for providing power to the satellite 300. In some examples, the satellite 300 includes rechargeable batteries used when sunlight is not reaching and charging the solar panels 308.

When constructing a global-scale communications system 100 using airborne base stations 200, it is sometimes desirable to route traffic over long distances through the system 100 by linking airborne base stations 200 to satellites 300 and/or one airborne base station 200 to another. For example, two satellites 300 may communicate via inter-device links and two airborne base stations 200 may communicate via inter-device links. Inter-device link (IDL) eliminates or reduces the number of airborne base stations 200 or satellites 300 to gateway 110 hops, which decreases the latency and increases the overall network capabilities. Inter-device links allow for communication traffic from one airborne base station 200 or satellite 300 covering a particular region to be seamlessly handed over to another airborne base station 200 or satellite 300 covering the same region, where a first airborne base station 200 or satellite 300 is leaving the first area and a second airborne base station 200 or satellite 300 is entering the area. Such inter-device linking is useful to provide communication services to areas far from source and destination ground stations 110a, 110b and may also reduce latency and enhance security (fiber optic cables may be intercepted and data going through the cable may be retrieved). This type of inter-device communication is different than the “bent-pipe” model, in which all the signal traffic goes from a source ground station 110a to a satellite 300, and then directly down to a destination ground station 110b (e.g., terrestrial terminal) or vice versa. The “bent-pipe” model does not include any inter-device communications.

Instead, the satellite 300 acts as a repeater. In some examples of “bent-pipe” models, the signal received by the satellite 300 is amplified before it is re-transmitted; however, no signal processing occurs. In other examples of the “bent-pipe” model, part or all of the signal may be processed and decoded to allow for one or more of routing to different beams, error correction, or quality-of-service control; however no inter-device communication occurs.

In some implementations, large-scale communication constellations are described in terms of a number of orbits 202, 302, and the number of airborne base stations 200 or satellites 300 per orbit 202, 302. Airborne base stations 200 or satellites 300 within the same orbit 202, 302 maintain the same position relative to their intra-orbit airborne base station 200 or satellite 300 neighbors. However, the position of an airborne base station 200 or a satellite 300 relative to neighbors in an adjacent orbit 202, 302 may vary over time. For example, in a large-scale satellite constellation with near-polar orbits, satellites 300 within the same orbit 202 (which corresponds roughly to a specific latitude, at a given point in time) maintain a roughly constant position relative to their intra-orbit neighbors (i.e., a forward and a rearward satellite 300), but their position relative to neighbors in an adjacent orbit 302 varies over time. A similar concept applies to the airborne base stations 200; however, the airborne base stations 200 move about the earth 5 along a latitudinal plane and maintain roughly a constant position to a neighboring airborne base station 200.

A source ground station 110a may be used as a connector between satellites 300 and the Internet, or between airborne base stations 200 and terrestrial terminals 110b. In some examples, the system 100 utilizes the source ground station 110a as linking-gateways 110a for relaying a communication 20 from one airborne base station 200 or satellite 300 to another airborne base station 200 or satellite 300, where each airborne base station 200 or satellite 300 is in a different orbit 202, 302. For example, the linking-gateway 110a may receive a communication 20 from an orbiting satellite 300, process the communication 20, and switch the communication 20 to another satellite 300 in a different orbit 302. Therefore, the combination of the satellites 300 and the linking-gateways 110a provide a fully-connected system 100. For the purposes of further examples, the gateways 110 (e.g., source ground stations 110a and destination ground stations 110b), shall be referred to as terrestrial terminals 110.

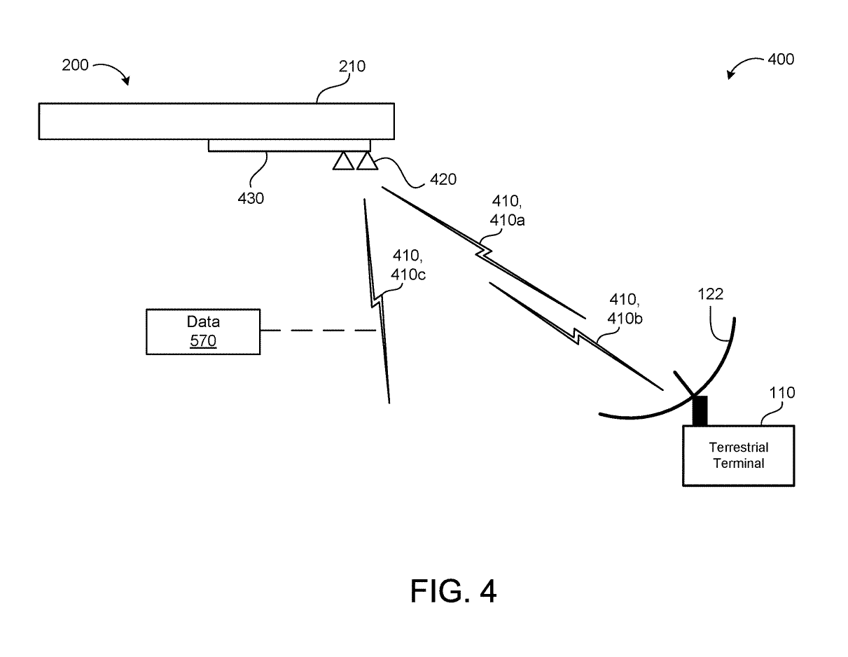

FIG. 4 provides a schematic view of an exemplary architecture of a communication system 400 establishing a communications link via a communication beam 410 between an airborne base station 200 and a terrestrial terminal 110 (e.g., a gateway 110). In some examples, the airborne base station 200 is an unmanned aerial system (UAS). In the example shown, the airborne base station 200 includes a body 210 that supports a LTE terminal 430. The LTE terminal 430 transmits multiple communication beams 410 via one or more antenna 420. Multiple communication beams 410 may be transmitted from a single antenna 420, multiple antennas 420 may each transmit a communication beam 410 or a combination of two. The communication beam 410 includes data 570, which can be transmitted to the terrestrial terminal 110 (e.g., radio signals or electromagnetic energy).

The terrestrial terminal 110 includes a ground antenna 122 designed to communicate with the airborne base station 200. The airborne base station 200 may communicate various data and information to the terrestrial terminal 110, such as, but not limited to, airspeed, heading, attitude, position, temperature, GPS (global positioning system) coordinates, wind conditions, flight plan information, fuel quantity, battery quantity, data received from other sources, data received from other antennas, sensor data, etc. The terrestrial terminal 110 may communicate to the airborne base station 200 various data and information including data to be forwarded to other terrestrial terminals 110 or to other data networks. The airborne base station 200 may be various implementations of flying craft including a combination of the following such as, but not limited to an airplane, airship, helicopter, gyrocopter, blimp, multi-copter, glider, balloon, fixed wing, rotary wing, rotor aircraft, lifting body, heavier than air craft, lighter than air craft, etc.

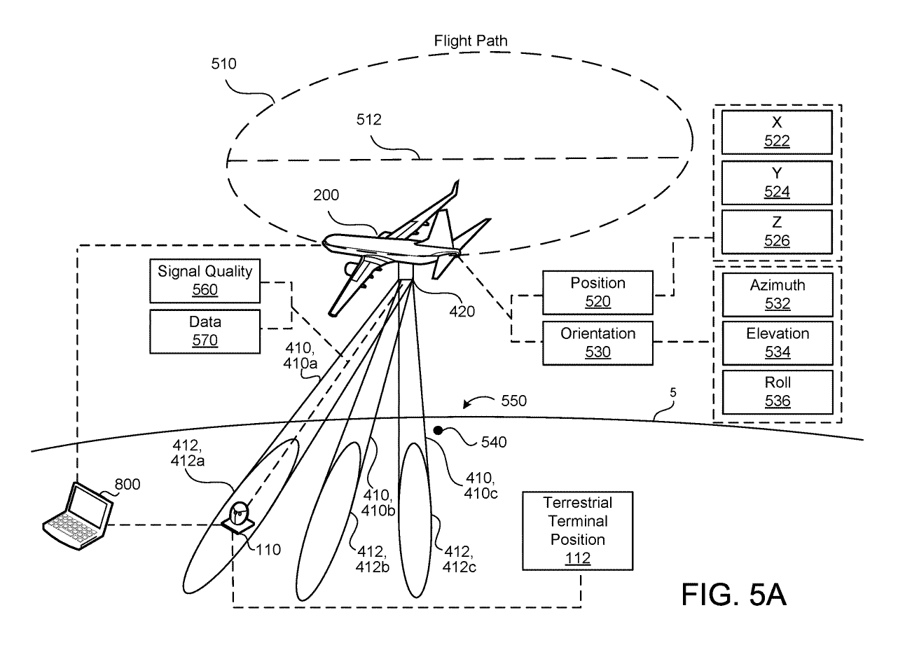

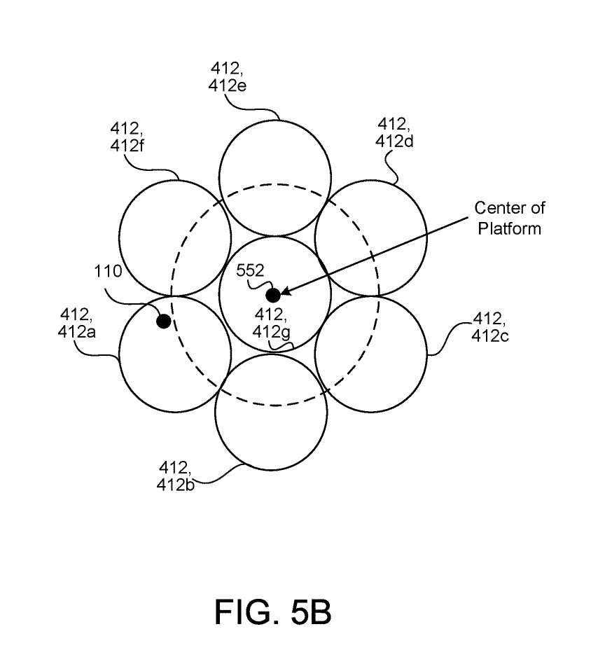

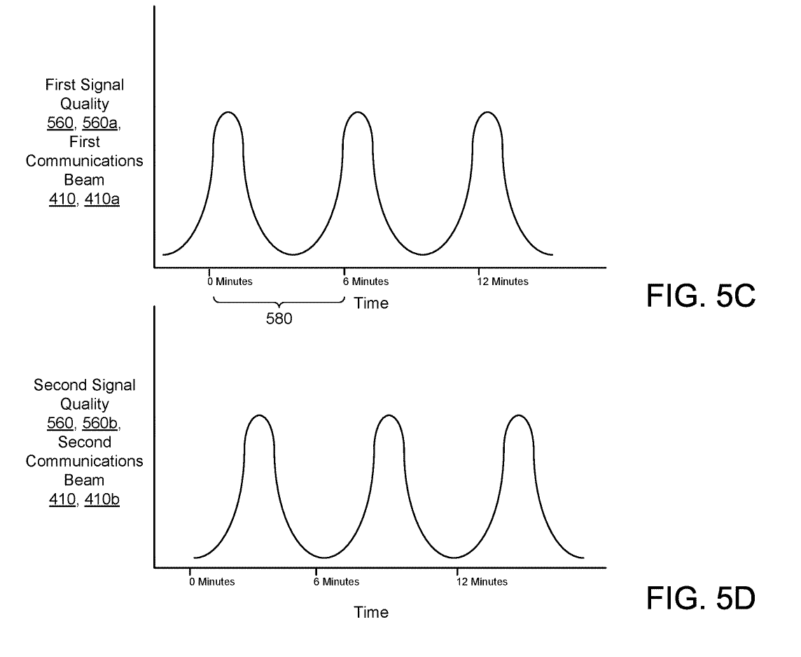

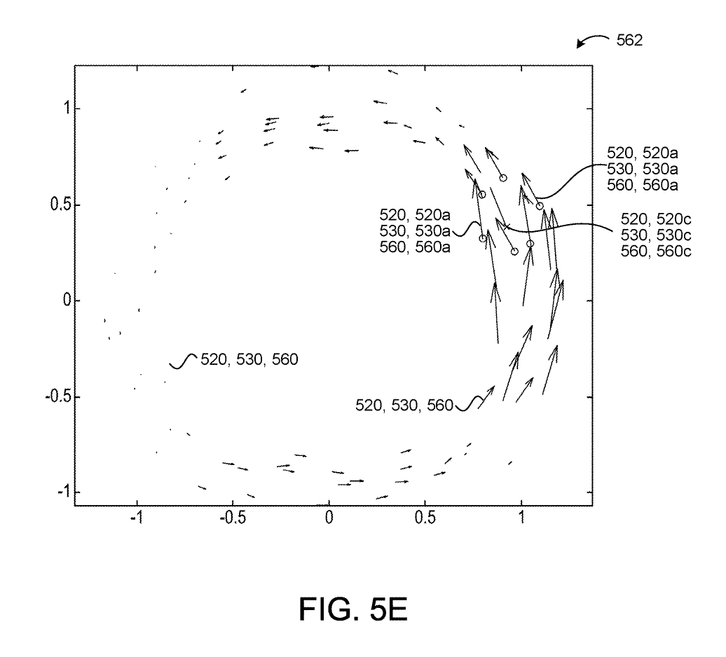

FIG. 5A displays a perspective schematic view of an example operating airborne base station 200. The airborne base station 200 may be operating over a given region of the earth 5 and maintain station keeping to provide service to a given target area 550 of earth 5. The airborne base station 200 may travel along a flight path 510. The flight path 510 may be roughly circular, but may include any closed or open shape. Unlike a satellite, an airplane generally cannot maintain a circular flight path without also changing attitude to compensate for wind. The flight path 510 may include a diameter 512 measured across two points of the flight path 510. In some examples, the airborne base station 200 maintains a majority of line of sight to the terrestrial terminal 110. In other examples, the diameter 512 of the flight path is less than a diameter of the earth 5 preventing gravitational based orbits. The airborne base station 200 and the flight path 510 may be fully enclosed in the atmosphere of the earth 5. As the airborne base station 200 moves along the flight path 510, the airborne base station 200 may transmit communications beams 410 to various terrestrial terminals 110. Each communication beam 410 may include a communication beam pattern 412, which defines an area during which the communication link using the communication beam 410 between the terrestrial terminal 110 and airborne base station 200 exists. The communication beam patterns 412 may be any shape and may be separate or they may overlap each other. The communication beam patterns 412 may not be required to have defined edges or be a given region. For example, as the airborne base station 200 travels clockwise around the flight path 510, a first communication beam 410, 410a with a first communication beam pattern 412, 412a comes into contact with the terrestrial terminal 110. The airborne base station 200 and terrestrial terminal 110 may communicate while the airborne base station 200 is in a position 520 and an orientation 530 to allow for the first communication beam 410, 410a and a first communication beam pattern 412, 412a to remain in contact with the terrestrial terminal 110. As the airborne base station 200 continues to move clockwise around the flight path 510, a second communication beam 410, 410b and a second communication beam pattern 412, 412b will come into contact with the terrestrial terminal 110, allowing for communication between the terrestrial terminal 110 and the airborne base station 200 using the second communication beam 410, 410b while the second communication beam pattern 412, 412b encompasses the terrestrial terminal 110. As the airborne base station 200 continues to move clockwise around the flight path 510, a third communication beam 410, 410c and a third communication beam pattern 412, 412c will come into contact with the terrestrial terminal 110, allowing for communication between the terrestrial terminal 110 and the airborne base station 200 using the third communication beam 410, 410c while the third communication beam pattern 412, 412c encompasses the terrestrial terminal 110. In some examples, multiple communication beam patterns 412 and communication beams 410 overlap, allowing for the terrestrial terminal 110 or airborne base station 200 to select between one of the communication beams 410 or transmissions across multiple communication beams 410.

As the airborne base station 200 flies along the flight path 510 while operating over a target area 550, the airborne base station 200 has a position 520 and an orientation 530 at a given moment in time. The position 520 may include an X-component 522, a Y-component 524 and a Z-component 526 with respect to a reference point. The X-component 522 is latitude, the Y-component 524 may be longitude, and the Z-component 526 may be altitude. In other examples, the X-component 522, Y-component 524, and Z-component 526 may be measurements relative to a ground reference 540. The ground reference 540 may be a plane, a point, or physical reference to provide a centering point.

When the antenna 420 is rigidly mounted to the airborne base station body 210, the orientation 530 may include an azimuth 532, an elevation 534, and a roll 536, which may be used to define the respective orientation 530 of the airborne base station 200 at a given moment in time. On the other hand, when the antenna 420 is mounted to the airborne base station body 210 a movable system, such as a gimbal system, then the orientation 530 is the orientation of the antenna 420. The orientation of the antenna 420 can be inferred from the orientation of the airborne base station 200 when combined with knowledge of the behavior of the gimbal system, or it can be measured directly. The orientation 530 including the azimuth 532, the elevation 534, and the roll 536 may be defined with respect to the ground reference 540 or may be arbitrarily defined providing relative measurements. The terrestrial terminal 110 or airborne base station 200 may be in communication with data processing hardware 800 in order to process and receive position 520, orientation 530, signal quality measurements 560, and/or data 570. Multiple data processing hardware 800 may be present, with separate units connected to the terrestrial terminal 110, and/or the airborne base station 200. In some examples, the data processing hardware 800 is separate and only in communication with both or either of the terrestrial terminal 110 or the airborne base station 200.

The signal quality 560 may be determined by the terrestrial terminal 110 (UE) delivering sounding reference signals or periodic quality measurements to the airborne base station 200 or the airborne base station 200 delivering sounding reference signals or periodic quality measurements to the terrestrial terminal 110 based on the 3GPP TS 36.331 specification. For example, the terrestrial terminal 110 may transmit special signals, such as sounding reference signals, to the airborne base station 200 and the airborne base station 200 measures their quality. The quality measurements are thus never transmitted over the air to/from the terrestrial terminal 110, or to/from the airborne base station 200. As another example, the airborne base station may transmit an RRCConnectionReconfiguration message to the terrestrial terminal 110 containing a MeasConfig information element. The MeasConfig, in turn, may contain a ReportConfigToAddModList and MeasIdToAddModList information elements. The ReportConfigToAddModList contains a ReportConfigEUTRA with type “periodical” and purpose “reportStrongestCells”. The MeasIdToAddModList contains a MeasId, MeasObjectId, and a ReportConfigId that may tie the new measurement report to the measurement object corresponding to the carrier frequency assigned to the primary (serving) cell of the airborne base station 200. After receiving this control message, per the 3GPP specification, the terrestrial terminal 110 may send one or more RRC messages periodically to the airborne base station 200 that contain measurements of the Reference Signal Receive Power (RSRP) representing the signal quality 560 of the serving communications beam 410 and of other significant communications beams 410 detected by the terrestrial terminal 110. In some examples, there is only a reported single quality 560 for the communications beams 410, because one of the communications beams 410 has a greater strength than the others. In other examples, near the edge of a communications beam 410 or wherever communications beams 410 overlap, multiple signal qualities 560 may be reported, including signal qualities 560 related to communications beams 410 from other airborne base stations 200. Communications beams 410 for which there is no report from the terrestrial terminal 110 may be assigned a low signal value. In some examples, the signal quality 560 is determined by a channel quality indicator, a sounding reference signal, or a periodic measurement in accordance with standard measurement practices. For example, with an airborne base station 200 operating on a six minute flight path 510 with six communication beams 410 passing over the terrestrial terminal 110 every six minutes, the sounding reference signal for signal quality 560 may be captured and measured at each communication beam 410 to form a time-series of signal quality estimates at the terrestrial terminal 110. This may yield 72 samples per circuit of the flight path 510, or roughly 12 samples for each beam during high conditions of high signal quality. If the signal quality is too low to be measured, a nominal low value may be assigned.

FIG. 5B is a top view of an exemplary pattern of communication beams 410 projected from a LTE terminal 430 on an airborne base station 200. The pattern of communication beams 410 includes seven communication beams 410, 410a-410g each creating their own communication beam pattern 412. The first communication beam pattern 412, 412a, the second communication beam pattern 412, 412b, the third communication beam pattern 412, 412c, a fourth communication beam pattern 412, 412d, a fifth communication beam pattern 412, 412e, and a sixth communication beam pattern 412, 412f surround a seventh communication beam pattern 412, 412g. As the airborne base station 200 operates in its flight path 510 and the position 520 changes, the respective position of the communication beams 410, 410a-410g and the communication beam patterns 410, 410a-410g, 410n appear to rotate and move in relation to the terrestrial terminal 110 on the ground. As the airborne base station 200 operates in its flight path 510 and the orientation 530 changes, the respective shape of the communication beams 410, 410a-410g and the communication beam patterns 410, 410a-410g to appear to distort and move in relation to the terrestrial terminal 110 on the ground. As the airborne base station 200 continues to operate in a predictable manner patrolling its orbit over its target area 550, the motion and shape of the communication beams 410, 410a-410g and the communication beam patterns 410, 410a-410g may become more regular and predictable. There is no limit to the number of communications beams 410 and communication beam patterns 412 that may be projected from the airborne base station 200. The communication beam pattern 412 may be centered around a center reference 552, which may be oriented at the target area 550 or directly at the ground reference 540. If the antenna 420 is rigidly mounted to a plane, the antenna 420 is the center of the flight circle of the plane. That is, if the platform is moving in a circle, the center reference 552 is the center of the circle. If on the other hand the antenna 420 is mounted via a gimbal, the center reference 552 may be the (terrestrial) aiming point of the gimbal.

FIG. 5C shows the perceived signal quality 560 in reference to a terrestrial terminal 110 for a first communication beam 410, 410a. As the airborne base station 200 patrols the target area 550 in a repeating pattern, the first signal quality 560, 560a increases and decreases with respect to time as the position 520 and orientation 530 change.

FIG. 5D shows the perceived second signal quality 560, 560b in reference to a terrestrial terminal 110 for a second communication beam 410, 410b. As the airborne base station 200 patrols the target area 550 in a repeating pattern, the second signal quality 560, 560b increases and decreases with respect to time as the position 520 and orientation 530 change.

Referencing FIGS. 5C-5D, at a time of zero minutes, six minutes, and 12 minutes, the first signal quality 560, 560a may be at or near its highest point, while by comparison, the second signal quality 560, 560b may be at or near its lowest point. The period of the signal quality 560 may be determined from the measurements themselves or from the position 520 and orientation 530 information from the airborne base station 200. The signal quality 560 of the respective communication beams 410 and associated signal quality 560 may be cyclic in response to the flight path 510 of the airborne base station 200 based on an approximate orbit time of six minutes. As the position 520 and orientation 530 of the airborne base station 200 changes, the respective signal quality 560 may oscillate in a semi-predictable pattern. A terrestrial terminal 110 or airborne base station 200 may choose to delay sending data through the communication beam 410 depending on the value of the signal quality 560 until it exceeds a threshold signal quality value. In other examples, the airborne base station 200 may switch from the first communication beam 410, 410a to the second communication beam 410, 410b based on the threshold signal quality value of the signal quality 560.

FIG. 5E displays an example graph of the signal quality 560 with respect to position 520 and orientation 530 for a given communication beam 410. For illustration purposes, the depicted FIG. 5E does not include the elevation 534 or the roll 536 or the Z-component 526, but the elevation 534, the roll 536 and the Z-component 526 may be processed as a three dimensional graph. The X-component 522 of position 520 may be represented on the X axis of the signal quality graph 562. The Y-component 524 of position 520 may be represented on the Y axis of the signal quality graph 562. The base of the arrow may be the position 520 of the airborne base station 200. The length of the arrow indicates the signal quality 560 of a particular communication beam 410 for a given terrestrial terminal 110. The length of the arrow is proportional to quality. The direction of the arrow represents the azimuth 532 as a vector. While only the angle of azimuth 532 is shown for clarity, the elevation 534 and roll 536 of the airborne base station 200 may be considered as well. A first signal quality measurement 560, 560a includes a first position 520, 520a and a first orientation 530, 530a. A second signal quality measurement 560, 560b includes a second position 520, 520b and a second orientation 530, 530b. A desired target signal quality 560, 560c measurement includes a target position 520, 520c and a target orientation 530, 530c. The data processing hardware 800 may use the first signal quality measurement 560, 560a including the first position 520, 520a and the first orientation 530, 530a and the second signal quality measurement 560, 560b including the second position 520, 520b and the second orientation 530, 530b to predict the target signal quality 560, 560c measurement based on the target position 520, 520c and target orientation 530, 530c.

One technique to predict the target signal quality 560, 560c is to gather N recent periods 580 worth of data. A Fourier series expansion using multiples of the base period as the fundamental frequencies of the expansion may be used to determine the target signal quality 560, 560c based on signal quality 560. The Fourier-based analysis may be optionally based on previous position 520 and orientation 530 as well. The most significant coefficients of the expansion may be retained and used to model a periodic extension of the past resulting in the target signal quality 560, 560c for a given communication beam 410.

The following example illustrates the Fourier prediction approach with a period 580 of N equal to 5 for a given communication beam 410. The sequence of 90 values of signal quality 560 is given as equation 1 representing signal quality 560 on a normalized linear scale from 0 to 1, and the most recent value is given last.

q=10.281, 0.31, 0.327, 0.003, 0.194, 0.16, 0.113, 0.009, 0.051, 0.039, 0.043, 0.029, 0.098, 0.17, 0.216, 0.207, 0.145, 0.02, 0.922, 0.708, 0.863, 0.533, 0.073, 0.217, 0.11, 0.155, 0.176, 0.01, 0.049, 0.032, 0.022, 0.079, 0.177, 0.197, 0.138, 0.421, 0.289, 0.052, 0.621, 0.823, 0.595, 0.006, 0.087, 0.216, 0.172, 0.156, 0.003, 0.003, 0.019, 0.051, 0.022, 0.013, 0.171, 0.217, 0.217, 0.022, 0.343, 0.579, 0.925, 0.979, 0.904, 0.714, 0.111, 0.155, 0.141, 0.184, 0.118, 0.007, 0.046, 0.046, 0.035, 0.007, 0.095, 0.193, 0.215, 0.162, 0.087, 0.598, 0.916, 0.842, 0.706, 0.759, 0.259, 0.189 0.197, 0.137, 0.03, 0.019, 0.046, 0.0141 Eq. (1)

These samples in equation 1 may be a length-90 vector q. The period 580 of motion for the airborne base station 200 is known to be 20 samples of signal quality 560 in this example. For this example, using the first five multiples of the fundamental frequency in equation 2 may provide acceptable prediction accuracy of the target signal quality 560.

$$f 1 = 0 , f 2 = 2 * \frac{pi}{20} , f 3 = 4 * \frac{pi}{40} , f 4 = 6 * \frac{pi}{20} , and \\ f 5 = 8 * pi / 20 \qquad Eq . ( 2 )$$

Each of the fundamental frequencies vectors may be assembled into a 9×90 matrix Q as defined by equations 3-12.

Q=[s1; s2; s3; s4; s5; c2; c3; c4; c5] Eq. (3)

s1=[sin(0*f1)sin(1*f1)sin(2*f1) . . . sin(89*f1)] Eq. (4)

s2=[sin(0*f2)sin(1*f2)sin(2*f2) . . . sin(89*f2)] Eq. (5)

s3=[sin(0*f3)sin(1*f3)sin(2*f3) . . . sin(89*f3)] Eq. (6)

s4=[sin(0*f4)sin(1*f4)sin(2*f4) . . . sin(89*f4)] Eq. (7)

s5=[sin(0*f5)sin(1*f5)sin(2*f5) . . . sin(89*f5)] Eq. (8)

c2=[cos(0*f2)cos(1*f2)cos(2*f2) . . . cos(89*f2)] Eq. (9)

c3=[cos(0*f3)cos(1*f3)cos(2*f3) . . . cos(89*f3)] Eq. (10)

c4=[cos(0*f4)cos(1*f4)cos(2*f4) . . . cos(89*f4)] Eq. (11)

c5=[cos(0*f5)cos(1*f5)cos(2*f5) . . . cos(89*f5)] Eq. (12)

A least-squares regression may be performed on Q of equation 3 to find the length-9 vector w that minimizes equation 13.

∥wQ−q∥² Eq. (13)

In this equation, ∥.∥² denotes the sum of squares or (L2 norm). For this example, w is defined as equation 14.

w=[0.2483, −0.1034, −0.0718, −0.0987, −0.0755, 0.2671, 0.1067, 0.0782, 0.0170] Eq. (14).

Using the coefficients w—which may be viewed as a Fourier series approximation—future quality values for signal quality 560 at samples n=90, 91, 92, . . . are determined by taking the dot product in equation 15.

$$w \cdot [ \begin{matrix}\begin{matrix}sin ( n * f 1 ) sin ( n * f 2 ) sin ( n * f 3 ) sin ( n * f 4 ) \\ sin ( n * f 5 ) cos ( n * f 2 ) cos ( n * f 3 )\end{matrix} \\ cos ( n * f 4 ) cos ( n * f 5 )\end{matrix} ] \qquad Eq . ( 15 )$$

Another method to compute the target signal quality 560 may be to take the last N periods 580 and take the median of the multiple values of signal quality 560 at each point in the cycle as the prediction for the next period 580. In some examples, if the time samples are not perfectly aligned, the samples are interpolated using interpolation methods, such as linear or polynomial interpolation. One advantage to the median approach is a robustness to outliers, while the Fourier approach applies a higher degree of smoothing.

The following example shows how the median method may be used to predict future signal quality 560 based on past signal quality measurements 560. In this example, the period 580 equals 3, and there are 20 samples of signal quality 560 per period 580. Signal quality 560 in this example may be determined by Reference Signal Receive Power (RSRP), measured in dBm, as defined in the LTE specification. Missing (unreported) RSRP values are set to −140 dBm. The following sequence of 60 RSRPs is received at the airborne base station 200 from the terrestrial terminal 110 as seen in equation 16.

$$\{ \begin{matrix}\begin{matrix}- 140 , - 140 , - 133 , - 120 , - 127 , - 140 , - 140 , \\ - 140 , - 140 , - 140 , - 140 , - 140 , - 140 ,\end{matrix} \\ \begin{matrix}- 140 , - 140 , - 140 , - 140 , - 140 , - 140 , - 140 , \vert - 140 , \\ - 139 , - 127 , - 122 , - 120 , - 140 ,\end{matrix} \\ \begin{matrix}- 140 , - 140 , - 140 , - 140 , - 140 , - 140 , - 140 , - 140 , \\ - 140 , - 140 , - 140 , - 140 , - 140 ,\end{matrix} \\ \begin{matrix}- 140 , \vert - 140 , - 140 , - 130 , - 122 , - 122 , - 140 , - 140 , \\ - 140 , - 140 , - 140 , - 140 , - 140 ,\end{matrix} \\ - 140 , - 140 , - 140 , - 140 , - 140 , - 140 , - 140 , - 140\end{matrix} \} \qquad Eq . ( 16 )$$

Referring to equation 16, the oldest signal quality 560 (sample 1) may be provided first and the most recent signal quality 560 (sample 60) may be provided last. For clarity, a vertical bar ‘|’ has been inserted to the left of sample 21 and sample 41 in equation 16. To predict the next 20 values of signal quality 560 (samples 61 through 80) using the median method, take the point-wise median of the previous three periods 580. For example, the prediction for the 61st signal quality 560 may be the median of the 1st, 21st, and 41st signal quality 560, which is the median of {−140,−140,−140}, which is −140. Similarly, the prediction for the 62nd signal quality 560 may be the median of 2nd, 22nd, and 42nd signal quality 560, which may be the median of {−140,−139,−140}, which is −140. This process may be repeated to determine as many target signal qualities 560 as needed and may be referenced to the position 520 and orientation 530 to further refine the prediction.

The value of N or the number of periods 580 used in the approach described previously may be selected based on the stability of the measurement data or signal qualities 560. If the terrestrial terminal 110 is moving rapidly on the ground, or if the flight pattern 510 of the airborne base station 200 has been modified, distant past measurements should be excluded by selecting a smaller value of N. Conversely, if the terrestrial terminal 110 is near stationary or if the flight pattern is consistent, N can be made larger. N can also be selected adaptively by trying different values of N and seeing which performs best on recent historical data of the signal qualities 560.

The prediction accuracy may be improved by forming an explicit model that links the position 520 and orientation 530 of the airborne base station 200, characterized for example by a length-6 vector x (which consists of a 3-D coordinate for position 520 plus azimuth 532, elevation 534 and roll 536) with s representing signal quality 560. An explicit model f from x to s is trained using past noisy samples of signal quality 560. A set of M past noisy samples is given in equation 17, where M should be large enough to encompass several periods 580.

(x₁, s₁), (x₂, s₂), . . . , (x_{M}, s_{M}) Eq. (17)

To predict the future signal quality 560, the next step is to determine a position 520 and orientation 530 (represented as x′) for which the prediction should be made. The value of x′ at some future time may be based, for example on flight planning information or linear extrapolation from the current position 520, velocity 528, and orientation 530. Next, f(x′) may be computed. One example, to determine the value of f at x′, first find the L past samples xᵢ₁, . . . , x_{iL} closest to x′, then perform linear regression to find an approximate linear function f′ from xᵢ₁, . . . , x_{iL} to sᵢ₁, . . . , s_{iL} respectively. The predicted signal quality f(x′) is equal to f′(x′). A new linear function f′ is determined for each different position/orientation x′.

One advantage to this approach is it does not require the airborne base station 200 to follow a periodic movement pattern or flight path 510. As long as a nearby position 520 and orientation 530 has been visited in the past, the past value may be used to predict future signal quality 560 near that position 520 and orientation 530.

With continued reference to FIG. 5E, which represents an example visualization of the position 520 of the airborne base station 200, the x- and y-axis units are in kilometers. A total of 80 measurements of signal quality 560 are represented, corresponding to roughly 4 complete circuits of the airborne base station 200. The arrow direction indicates the orientation 530 of the airborne base station 200. Only the angle of azimuth 532 is shown; the elevation 534 and roll 536 of the airborne base station 200 is not depicted for clarity. The base of the arrow may be the position 520 of the airborne base station 200. The length of the arrow indicates the signal quality 560 of a particular communication beam 410 for a given terrestrial terminal 110. The x at the arrow may be the position 520 and orientation 530 of the airborne base station 200 for which prediction of the signal quality 560 may be required. The six signal qualities 560 with circles are the six measurements closest (in a mathematical sense) to the position 520 and orientation 530 of the airborne base station 200 for which signal quality 560 is to be predicted. As an example, the position 520 and orientation 530 of the airborne base station 200 indicated by the signal quality 560 have coordinates in equation 18.

$$[ \begin{matrix}\begin{matrix}X & Y & U & V\end{matrix} \\ 0.9661 , 0.2583 , - 0.4986 , 0.8668 , \\ 1.0980 , 0.4916 , - 0.4720 , 0.8816 , \\ 1.0472 , 0.2988 , - 0.1574 , 0.9875 \\ 0.9029 , 0.6402 , - 0.4973 , 0.8676 , \\ 0.7966 , 0.5529 , - 0.5552 , 0.8317 , \\ 0.8008 , 0.3251 , - 0.1329 , 0.9911\end{matrix} ] . \qquad Eq . ( 18 )$$

The first two columns are the x coordinate 522 and the y coordinate 524 of the position 520 of the airborne base station and the last two columns are the x and y coordinates of a unit vector (u,v) normal to the orientation 530 of the airborne base station 200 to a ground reference 540. A normal vector may be one way to represent the azimuth 532 of the airborne base station 200, instead of using an angle. One advantage of using a normal vector representation of angle may be that it does not suffer from a “wrap around” discontinuity when the angle changes from 359 degrees to 0 degrees. In this example, the elevation 534 and the roll 536 of the airborne base station 200 is ignored. If present, these values would be represented as additional dimensions. The position 520 and orientation 530 of the airborne base station 200 for which a desired prediction of signal quality 560, marked by a ‘x’ in FIG. 5E and has coordinates in equation 19.

p=[0.9239, 0.3827, −0.3827, 0.9239] Eq. (19)

The target signal quality 560 is at position (0.9239,0.3827) and the orientation points up and to the left in FIG. 5E, in the direction (−0.3827,0.9239).

These six previous measurements of location of position 520 and orientation 530 of the airborne base station 200 were selected from among the 80 available historical measurements shown in FIG. 5E by finding those with the minimum Euclidean distance to the target position 520 and target orientation 530 of the airborne base station 200. The six signal quality 560 of the six selected historical location of position 520 and orientation 530 of the airborne base station 200 in this example are q in equation 20.

q=[0.6035, 0.6093, 0.9298, 0.5545, 0.4816, 0.9475] Eq. (20)

A linear least squares regression may be used to compute a vector w such that equation 21 is minimized. The vector w that minimizes equation 21 in this example is given in equation 22.

∥Aw−q′∥ Eq. (21)

w=[0.0268, −0.1305, 0.6124, 1.0555] Eq. (22)

To predict the signal quality 560, the data processing hardware 800 computes the dot product w dot p to be 0.7156, where p may be the target position 520 and target orientation 530 of the airborne base station 200 for which signal quality 560 is to be predicted, resulting in a predicted target signal quality 560 of 0.7165 for this example.

In some examples, to improve robustness of the prediction, the data processing hardware 800 first determines if the convex hull of the L nearest historical points contains the position 520 and orientation 530 of the airborne base station 200 to be predicted. If the position 520 and orientation 530 of the airborne base station 200 to be predicted is contained with the convex hull of the L nearest historical points, linear regression may be continued. If the position 520 and orientation 530 of the airborne base station 200 to be predicted is not contained with the convex hull of the L nearest historical points, use the prediction of the signal quality 560 of the nearest historical coordinate of the position 520 and orientation 530 of the airborne base station 200. This may result in linear regression being used only for interpolation, not for extrapolation helping prevent excess noise.

In some examples, when multiple terrestrial terminals 110 are present, prediction of the target signal quality 560 can be further improved, or the number of samples per terrestrial terminal 110 may be reduced by combining predictors across terrestrial terminals 110. For example, measurement records of signal quality 560 from hundreds of terminals are available to be used. First, measurement records of signal quality 560 may be aligned by applying a cyclic shift to azimuth 532, elevation 534, and roll 536 and a linear shift to position 520 so that the point of greatest signal quality 560 for each measurement records of signal quality 560 is at the origin. An automatic clustering method to group the measurement records of signal quality 560 into sets that are similar to each other near the origin may be applied. The terrestrial terminal location 112 may not be required to compute the target signal quality 560. Instead of using measurement records of signal quality 560 to predict signal quality 560 for a terrestrial terminal 110, use all measurement records of signal quality 560 of a similar set.

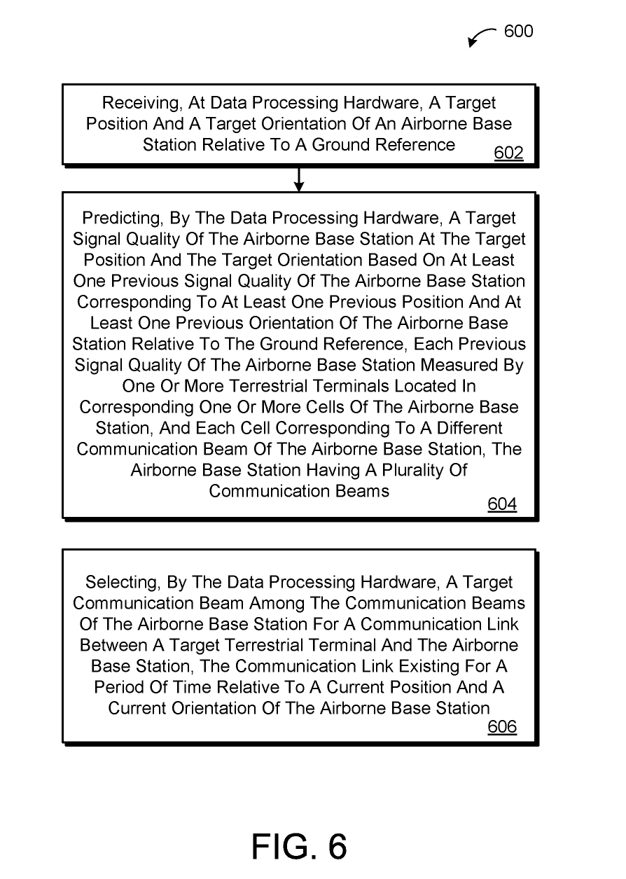

FIG. 6 illustrates a method 600 for predicting signal quality 560 from an airborne base station 200. At block 602, the method 600 includes receiving, at data processing hardware 800, a target position 520, 520c and a target orientation 530, 530c of an airborne base station 200 relative to a ground reference 540. The airborne base station 200 may transmit details regarding the position 520 including X 522, Y 524, and Z 526 positions to the data processing hardware 800. The airborne base station 200 may transmit details regarding the orientation 530 including azimuth 532, elevation 534, and roll 536 orientations to the data processing hardware 800. The position 520 including X 522, Y 524, and Z 526 and the orientation 530 including azimuth 532, elevation 534, and roll 536 may be a past position 520 and past orientation 530 for recording of measurements of signal quality 560 or a future position 520 and future orientation 530 for prediction of future signal quality 560. The position 520 and orientation 530 may be transmitted as data 570 or in addition to the data 570. At block 604, the method 600 includes predicting, by the data processing hardware 800, a target signal quality 560, 560c of the airborne base station 200 at the target position 520, 520c and the target orientation 530, 530c based on at least one previous signal quality 560, 560a of the airborne base station 200 corresponding to at least one previous position 520, 520a and at least one previous orientation 530, 530a of the airborne base station 200 relative to the ground reference 540. Each previous signal quality 560, 560a of the airborne base station 200 may be measured by one or more terrestrial terminals 110 located in corresponding one or more cells or communication beams 410 of the airborne base station 200. Each cell corresponds to a different communication beam 410 of the airborne base station 200. The airborne base station 200 has a plurality of communication beams 410. The prediction may be accomplished by examination of the position 520 and orientation 530 of the airborne base station 200, characterized for example by a length-6 vector x (which consists of a 3-D coordinate for position 520 plus azimuth 532, elevation 534 and roll 536) with s representing signal quality 560. The method may include constructing a function f from x to s, based on past noisy samples of signal quality 560 (x₁, s₁), (x₂, s₂), . . . , (x_{M}, s_{M}), where M is large enough to encompass several periods 580. To predict the future signal quality 560, the future position 520 and orientation 530 of the airborne base station 200 may be predicted based, for example on flight planning information or linear extrapolation from the current position 520, velocity 528, and orientation 530. Next, f(x′) may be computed. One example, to determine the value of f at x′, first find the L samples xᵢ_{₁}, . . . , xᵢ_{_{L}} closest to x′, then perform linear regression to find an approximate linear function f′ from xᵢ_{₁}, . . . , xᵢ_{_{L}} to sᵢ_{₁}, . . . , sᵢ_{_{L}} respectively. The method may include estimating f(x′) as f′(x′). A linear least squares regression, equation 21, may be used to compute a vector w such that equation 21 may be minimized. The dot product w dot p may be computed to determine target signal quality 560, where p may be the target position 520 and target orientation 530 of the airborne base station 200. Additional methods to determine the target signal quality 560 are described above.

At block 606, the method 600 further includes selecting, by the data processing hardware 800, a target communication beam 410, 410c among the communication beams 410 of the airborne base station 200 for a communication link between a target terrestrial terminal 110 and the airborne base station 200. The communication link exists for a period of time relative to a current position 520 and a current orientation 530 of the airborne base station 200. The communication link may be used to transmit data 570. The length of the period of time the communication link remains viable relates to the position 520, orientation 530, speed, and flight path 510 of the airborne base station 200.

In some implementations, at least one previous signal quality 560 includes a reference signal receive power measurement. The method 600 may also include transmitting, by the data processing hardware 800, data 570 using the target communication beam 410, 410c. The method 600 may further include delaying, by the data processing hardware 800, transmission of the data 570 using the target communication beam 410, 410c until the target signal quality 560, 560c satisfies a threshold signal quality 560. In some examples, when the target signal quality 560, 560c of the target communication beam 410 fails to satisfy a threshold signal quality 560, the method 600 includes, selecting, by the data processing hardware 800, an alternative communication beam 410, 410b among the communication beams 410 of the airborne base station 200 for the communication link between the target terrestrial terminal 110 and the airborne base station 200, the alternative communication beam 410, 410b may be different from the target communication beam 410, 410a; and transmitting, by the data processing hardware 800, data 570 using the alternative communication beam 410, 410b. The target position 520 may include a current position 520, 520a or a future position 520, 520c of the airborne base station 200. Predicting the target signal quality 560 may be based at least in part on a Fourier series expansion using multiples of a base period 580. The target signal quality 560 may be estimated based on a sounding reference signal. The airborne base station 200 may maintain a flight path 510 within a majority of a line of sight of the target terrestrial terminal 110. The airborne base station 200 may also maintain a flight path 510 having a diameter that may be approximately at or less than a diameter of earth 5.

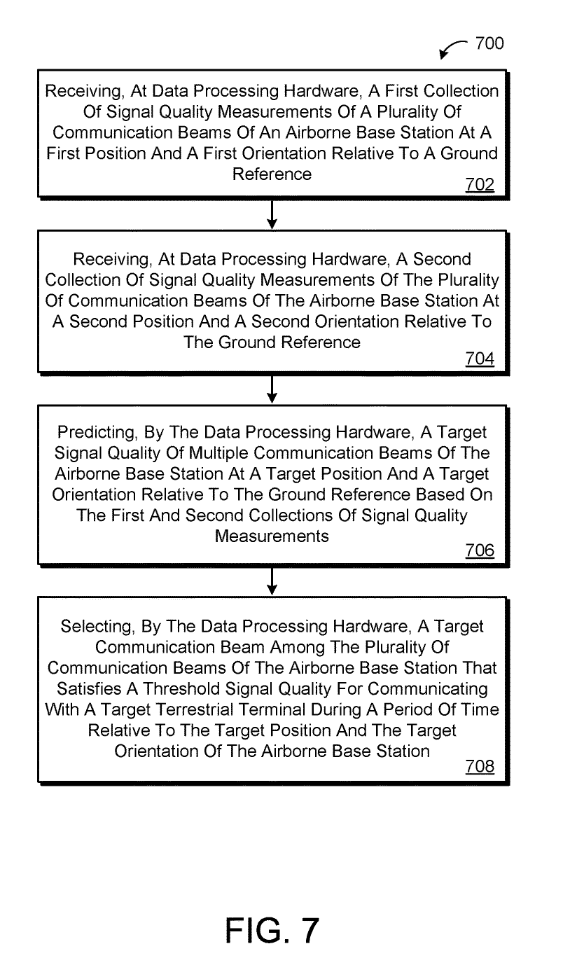

FIG. 7 displays a method 700 for predicting signal quality 560 from an airborne base station 200. At block 702, the method 700 includes receiving, at data processing hardware 800, a first collection of signal quality measurements 560, 560a of a plurality of communication beams 410 of an airborne base station 200 at a first position 520, 520a and a first orientation 530, 530a relative to a ground reference 540. The data processing hardware 800 may receive multiple signal quality measurements 560 related to one or more communication beams 410 directed at the airborne base station 200 or the terrestrial terminal 110. At block 704, the method 700 includes receiving, at data processing hardware 800, a second collection of signal quality measurements 560, 560b of the plurality of communication beams 410 of the airborne base station 200 at a second position 520, 520b and a second orientation 530, 530b relative to the ground reference 540. The data processing hardware 800 may receive multiple signal quality measurements 560 related to one or more communication beams 410 directed at the airborne base station 200 or the terrestrial terminal 110. At block 706, the method 700 includes predicting, by the data processing hardware 800, a target signal quality 560, 560c of multiple communication beams 410 of the airborne base station 200 at a target position 520, 520c and a target orientation 530, 530c relative to the ground reference 540 based on the first and second collections of signal quality measurements 560, 560a, 560b. The first and second collections of signal quality measurements 560, 560a, 560b in combination with the respective position 520 and orientation 530 of the airborne base station 200 at the time the signal quality measurement 560 was collected.

One method for predicting the signal quality 560 may be to apply a least squares method such that equation 21 may be minimized. Upon the minimization of equation 21, the computation of the dot product of target position 520, 520c and target orientation 530, 530c may be determined, resulting in the target signal quality 560, 560c. Additional methods, such as a Fourier prediction or median prediction may be applicable as described above.

At block 708, the method 700 further includes selecting, by the data processing hardware 800, a target communication beam 410, 410c among the plurality of communication beams 410 of the airborne base station 200 that satisfies a threshold signal quality 560 for communicating with a target terrestrial terminal 110 during a period of time relative to the target position 520, 520c and the target orientation 530, 530c of the airborne base station 200. The airborne base station 200 or terrestrial terminal 110 may select a communication beam 410 for communication or transmission of other data 570. The threshold signal quality 560 may be determined in accordance with an acceptable amount of communication loss or an optimal transmission capacity. In some examples, multiple airborne base stations 200 and terrestrial terminals 110 are performing the selection simultaneously.

In some implementations of the method 700, each signal quality measurement 560 includes a reference signal receive power measurement. The method 700 may also include transmitting, by the data processing hardware 800, data 570 using the target communication beam 410, 410c. The method 700 may further include delaying, by the data processing hardware 800, transmission of the data 570 using the target communication beam 410, 410c until the target signal quality 560, 560c of the target communication beam 410, 410c satisfies the threshold signal quality 560. When the target signal quality 560, 560c of the target communication beam 410, 410c fails to satisfy a threshold signal quality 560, the method 700 may include, selecting, by the data processing hardware 800, an alternative communication beam 410, 410b among the plurality of communication beams 410 of the airborne base station 200 for communicating between the target terrestrial terminal 110 and the airborne base station 200, the alternative communication beam 410, 410b different from the target communication beam 410, 410c and transmitting, by the data processing hardware 800, data 570 using the alternative communication beam 410, 410b.

In some examples, predicting the target signal quality 560, 560c of the multiple communication beams 410 of the airborne base station 200 at the target position 520, 520c and the target orientation 530, 530c relative to the ground reference 540 is at least in part based on one or both of a target terrestrial area 550 of the target terrestrial terminal 110 or a target terrestrial terminal position 112 of the target terrestrial terminal 110. The target orientation 530 may include an azimuth 532, an elevation 534, and a roll 536. Predicting the target signal quality 560 of the multiple communication beams 410 of the airborne base station 200 at the target position 520, 520c and the target orientation 530, 530c relative to the ground reference 540 may also be based on at least one of a channel quality indicator, a sounding reference signal, or a periodic measurement. Predicting the target signal quality 560, 560c of the multiple communication beams 410 of the airborne base station 200 at the target position 520, 520c and the target orientation 530, 530c relative to the ground reference 540 may be further based at least in part on a Fourier series expansion using multiples of a base period 580. Predicating the target signal quality 560, 560c of the multiple communication beams 410 of the airborne base station 200 at the target position 520, 520c and the target orientation 530, 530c relative to the ground reference 540 may also be based at least in part on a median signal quality value of over a base period 580.

In some examples, the airborne base station 200 maintains a flight path 512 within a majority of a line of sight of the target terrestrial terminal 110. The airborne base station 200 may maintain a flight path 510 with a diameter 512 that may be at or less than 25 miles. The airborne base station 200 may also maintain a flight path 510 having a diameter 512 that may be at or less than a diameter of earth 5.

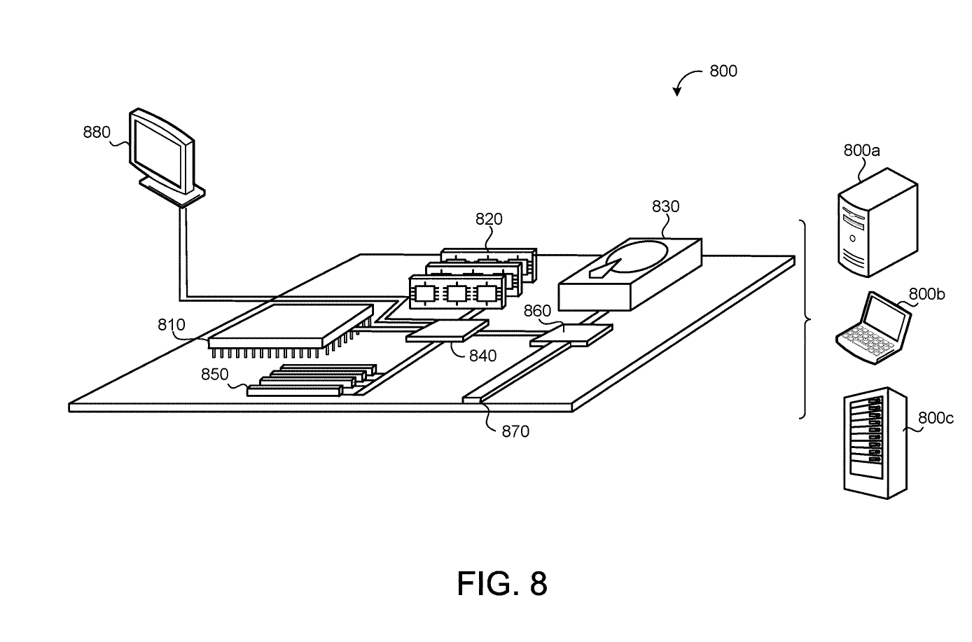

FIG. 8 is schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to low speed bus 870 and storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and low-speed expansion port 870. The low-speed expansion port 870, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware, a target position and a target orientation of an airborne base station relative to a ground reference;
predicting, by the data processing hardware, a target signal quality of the airborne base station at the target position and the target orientation based on at least one previous signal quality of the airborne base station corresponding to at least one previous position and at least one previous orientation of the airborne base station relative to the ground reference, each previous signal quality of the airborne base station measured by one or more terrestrial terminals located in corresponding one or more cells of the airborne base station, and each cell corresponding to a different communication beam of the airborne base station, the airborne base station having a plurality of communication beams; and
selecting, by the data processing hardware, a target communication beam among the communication beams of the airborne base station for a communication link between a target terrestrial terminal and the airborne base station, the communication link existing for a period of time relative to a current position and a current orientation of the airborne base station.

2. The method of claim 1, wherein the at least one previous signal quality comprises a reference signal receive power measurement.

3. The method of claim 1, further comprising transmitting, by the data processing hardware, data using the target communication beam.

4. The method of claim 3, further comprising delaying, by the data processing hardware, transmission of the data using the target communication beam until the target signal quality satisfies a threshold signal quality.

5. The method of claim 1, further comprising:
when the target signal quality of the target communication beam fails to satisfy a threshold signal quality:
selecting, by the data processing hardware, an alternative communication beam among the communication beams of the airborne base station for the communication link between the target terrestrial terminal and the airborne base station, the alternative communication beam different from the target communication beam; and
transmitting, by the data processing hardware, data using the alternative communication beam.

6. The method of claim 1, wherein the target position comprises a current position or a future position of the airborne base station.

7. The method of claim 1, wherein predicting the target signal quality is based at least in part on a Fourier series expansion using multiples of a base period.

8. The method of claim 1, further comprising estimating the target signal quality based on a sounding reference signal.

9. The method of claim 1, wherein the airborne base station maintains a flight path within a majority of a line of sight of the target terrestrial terminal.

10. The method of claim 1, wherein the airborne base station maintains a flight path having a diameter that is approximately at or less than a diameter of earth.

11. A method comprising:
receiving, at data processing hardware, a first collection of signal quality measurements of a plurality of communication beams of an airborne base station at a first position and a first orientation relative to a ground reference;
receiving, at data processing hardware, a second collection of signal quality measurements of the plurality of communication beams of the airborne base station at a second position and a second orientation relative to the ground reference;
predicting, by the data processing hardware, a target signal quality of multiple communication beams of the airborne base station at a target position and a target orientation relative to the ground reference based on the first and second collections of signal quality measurements; and
selecting, by the data processing hardware, a target communication beam among the plurality of communication beams of the airborne base station that satisfies a threshold signal quality for communicating with a target terrestrial terminal during a period of time relative to the target position and the target orientation of the airborne base station.

12. The method of claim 11, wherein each signal quality measurement comprises a reference signal receive power measurement.

13. The method of claim 11, further comprising transmitting, by the data processing hardware, data using the target communication beam.

14. The method of claim 13, further comprising delaying, by the data processing hardware, transmission of the data using the target communication beam until the target signal quality of the target communication beam satisfies the threshold signal quality.

15. The method of claim 11, further comprising:
when the target signal quality of the target communication beam fails to satisfy a threshold signal quality:
selecting, by the data processing hardware, an alternative communication beam among the plurality of communication beams of the airborne base for communicating between the target terrestrial terminal and the airborne base station, the alternative communication beam different from the target communication beam; and
transmitting, by the data processing hardware, data using the alternative communication beam.

16. The method of claim 11, wherein predicting the target signal quality of the multiple communication beams of the airborne base station at the target position and the target orientation relative to the ground reference is at least in part based on one or both of a target terrestrial area of the target terrestrial terminal or a target terrestrial position of the target terrestrial terminal.

17. The method of claim 11, wherein the target orientation comprises an azimuth, an elevation, and a roll.

18. The method of claim 11, wherein predicting the target signal quality of the multiple communication beams of the airborne base station at the target position and the target orientation relative to the ground reference is based on at least one of a channel quality indicator, a sounding reference signal, or a periodic measurement.

19. The method of claim 11, wherein predicting the target signal quality of the multiple communication beams of the airborne base station at the target position and the target orientation relative to the ground reference is based at least in part on a Fourier series expansion using multiples of a base period.

20. The method of claim 11, wherein predicating the target signal quality of the multiple communication beams of the airborne base station at the target position and the target orientation relative to the ground reference is based at least in part on a median signal quality value of over a base period.

21. The method of claim 11, wherein the airborne base station maintains a flight path within a majority of a line of sight of the target terrestrial terminal.

22. The method of claim 11, wherein airborne base station maintains a flight path with a diameter that is at or less than 25 miles.

23. The method of claim 11, wherein the airborne base station maintains a flight path having a diameter that is at or less than a diameter of earth.

24. A system comprising:
data processing hardware; and
memory hardware in communication with the data processing hardware, the memory hardware storing instructions that when executed on the data processing hardware cause the data processing hardware to perform operations comprising:
receiving a target position and a target orientation of an airborne base station relative to a ground reference;
predicting a target signal quality of the airborne base station at the target position and the target orientation based on at least one previous signal quality of the airborne base station corresponding to at least one previous position and at least one previous orientation of the airborne base station relative to the ground reference, each previous signal quality of the airborne base station measured by one or more terrestrial terminals located in corresponding one or more cells of the airborne base station, and each cell corresponding to a different communication beam of the airborne base station, the airborne base station having a plurality of communication beams; and
selecting a target communication beam among the communication beams of the airborne base station for a communication link between a target terrestrial terminal and the airborne base station, the communication link existing for a period of time relative to a current position and a current orientation of the airborne base station.

25. The system of claim 24, wherein the at least one previous signal quality comprises a reference signal receive power measurement.

26. The system of claim 24, wherein the operations further comprise transmitting data using the target communication beam.

27. The system of claim 26, wherein the operations further comprise delaying transmission of the data using the target communication beam until the target signal quality satisfies a threshold signal quality.

28. The system of claim 24, wherein the operations further comprise:
when the target signal quality of the target communication beam fails to satisfy a threshold signal quality:
selecting an alternative communication beam among the communication beams of the airborne base station for the communication link between the target terrestrial terminal and the airborne base station, the alternative communication beam different from the target communication beam; and
transmitting data using the alternative communication beam.

29. The system of claim 24, wherein the target position comprises a current position or a future position of the airborne base station.

30. The system of claim 24, wherein predicting the target signal quality is based at least in part on a Fourier series expansion using multiples of a base period.

31. The system of claim 24, wherein the operations further comprise estimating the target signal quality based on a sounding reference signal.

32. The system of claim 24, wherein the airborne base station maintains an flight path within a majority of a line of sight of the target terrestrial terminal or the flight path having a diameter that is approximately at or less than a diameter of earth.
